(19) United States
(12) Patent Application Publication
(10) Pub. No.: US 2022/0073396 A1
(43) Pub. Date: Mar. 10, 2022

(54) PROCESS AND APPARATUS FOR WATER TREATMENT

(71) Applicant: INFINITE WATER TECHNOLOGIES PTY LTD, Brisbane Queensland (AU)

(72) Inventors: Mohammad KALANTARI, Brisbane Queensland (AU); Gheorghe DUTA, Brisbane Queensland (AU); Jessy LEE, Brisbane Queensland (AU); Kalaruban MAHATHEVA, Brisbane Queensland (AU)

(21) Appl. No.: 17/455,552

(22) Filed: Nov. 18, 2021

Related U.S. Application Data
(63) Continuation of application No. PCT/AU2020/050510, filed on May 22, 2020.

(30) Foreign Application Priority Data
May 24, 2019 (AU) 2019901789

(51) Int. Cl. C02F 9/00

(52) U.S. Cl. CPC C02F 9/00; C02F 2101/36

(57) ABSTRACT

A process for treating water contaminated with refractory organic matter, such as per- and polyfluoroalkyl substances (PFASs), comprising the following steps: (a) lowering the pH of the water for hydrolysis of organic matter; (b) subjecting the water with lowered pH to catalytic reduction by zero valent iron for organic matter degradation; (c) optionally aerating the water to oxidise the iron to ferric hydroxide; (d) optionally clarifying the water; and (e) optionally a catalytic advanced oxidation step. A system for conducting the process is also disclosed.

### CROSS-REFERENCES TO RELATED APPLICATIONS

This application is a continuation application of International Patent Application No. PCT/AU2020/050510 entitled “PROCESS AND APPARATUS FOR WATER TREATMENT,” filed on May 22, 2020, with claims priority to Australian Patent Application No. 2019901789, filed on May 24, 2019, each of which are herein incorporated by reference in their entirety for all purposes

### FIELD

This disclosure generally relates to process and apparatus for treating water contaminated with refractory organic matter, for example per- and polyfluoroalkyl substances (PFASs), or other refractory organic compounds.

### BACKGROUND

Clean, safe water is indispensable for people and the biota of our planet. Refractory organic matter, for example, per- and polyfluoroalkyl substances (PFASs), polycyclic aromatic hydrocarbons, phenols and certain amines, is highly persistent in the environment and can be bio accumulative.

Taking PFASs as an example, these are now widespread in the environment and their presence has been identified even in the blood of polar bears. PFASs are known carcinogens and pose serious health risks, and likely many yet unknown risks.

PFASs are a family of synthetic chemicals that have been produced since the late 1940s. The molecular structures of PFASs typically comprise:

(a) a hydrophobic carbon chain (2-16 carbons in length), in which either all (i.e. per-) or part (i.e. poly-) of the hydrogens are substituted by fluorine atoms such that they include no less than one fluoroalkyl moiety (CₙF₂ₙ₊₁); and

(b) hydrophilic polar functional groups such as carboxylates, sulfonates, sulphonamides, phosphonates and alcohols.

The small atomic size and robust electronegativity of fluorine affords unique properties to PFASs, such as extraordinary stability, strong acidity, high surface activity at very low concentrations, and/or water- and oil-repellency in comparison with their hydrocarbon counterparts. Hence, a broad range of industries have exploited PFASs as processing additives and as surfactants. Common consumer products that utilize PFASs consist of fire-fighting foams, metal plating, non-stick cookware, medical devices, specialized garments and textiles, and stain repellents.

Because of widespread applications, PFASs have been identified in industry facilities, commercial household products, drinking and waste water, human food, and even living organisms. Contact with PFASs, even at trace level, may result in PFAS accumulation in the human blood. Laboratory animal model studies have revealed that PFAS exposure may lead to adverse effects such as developmental impairment, hepatotoxicity, immunotoxicity, tumour induction, neurotoxicity and endocrine disruption. While human health risk assessments of PFASs exposure are still in their infancy, proof on links between PFAS exposure and human disease parameters has emerged. Carcinogenicity and immunotoxicity of PFASs have already been confirmed in experimental studies. The cost of PFAS to human health is only now starting to be realised, with health costs from exposure to these chemicals in Europe alone at between $AUD 80 billion to $AUD 132 billion a year. Consequently, in recent years, the occurrence, fate and removal of PFASs in the aquatic environment have been documented as key emerging issues.

The PFASs family consists of more than 3000 individual compounds and three subclasses; ultra-short-chain PFASs (C=2-3), short-chain PFASs (C=4-7), and long-chain PFASs (C>7) where C is carbon number. Previous studies have indicated that long-chain PFASs have a higher potential to bioconcentrate and bioaccumulate as compared to ultra-short-chain and short-chain PFASs, which generally exhibit higher water solubility and more mobility. Thus, long-chain PFASs, in particular, perfluorooctanoic acid (PFOA) and perfluorooctanesulfonate (PFOS), have received worldwide attention in the scientific and regulatory community and among the public since the late 1990s, due to their bioaccumulation potential, persistence, toxicity, and ubiquitous presence in the environment. The Stockholm Convention on Persistent Organic Pollutants in 2009 shortlisted PFOS as a Persistent Organic Pollutant (POP). The United States Environmental Protection Agency (USEPA) projected PFOA as a likely carcinogen. Recently, by further understanding of the fate, transport, bioaccumulation potential, and toxicology of perfluorohexane sulfonic acid (PFHxS) and perfluorohexanoic acid (PFHxA), regulations are broadening to include PFHxS. Accordingly, developing technologies for efficient PFOA, PFOS, and PFHxS and PFHxA removal from water are extremely urgent.

Due to the high electronegativity of fluorine, C—F bonds are extremely strong. Therefore, conventional treatments developed to degrade organic pollutants such as traditional oxidation processes, and advanced oxidation processes based on production of highly reactive species (e.g., hydroxyl radicals) are incapable of achieving this aim. Granular activated carbon (GAC), ion-exchange resins, and filtration methods have been used to remove PFASs from water matrix. The currently accepted remediation technology for water polluted by PFASs is adsorption onto GAC. To effectively destroy PFASs adsorbed on GAC, high-temperature (>1000° C.) incineration is required, making the treatment method expensive. Unfortunately, incineration also leads, in part, to recombination of degraded organic substances resulting in production of secondary contaminants. An example is dioxins resulting from incineration of plastics. The effectiveness of GAC to remove PFASs sharply decreases in the presence of competing organic pollutants. Ion-exchange resins can remove a wide array of PFASs but struggle to treat the short-chain PFASs. The presence of competing ions such as sulfate could reduce the efficiency of ion-exchange resins to remove PFASs compounds. Additionally, the regeneration process to activate exhausted (fully loaded) resins results in a concentrated solution of PFASs which raises further concerns for storage or disposal. Diverse categories of filtration technology such as nanofiltration (NF) and reverse osmosis (RO) membranes can be employed to treat PFASs-contaminated water. The desirable pore sizes of 1-10 nm and less than 1 nm for NF and RO membranes, respectively, are capable of efficiently remove PFASs from water matrix. Nevertheless, the relatively high operating cost is the key factor limiting the efficiency of the treatment. More importantly, NF and RO membranes produce a concentrated solution of PFASs which raises further concerns for storage or disposal. Collectively, the main concern for current treatment technologies is the fate of PFASs and further steps should be considered to collect, store and degrade PFASs. To tackle these issues, there have been efforts to advance treatment technologies for in-situ degradation of PFASs. However, candidate treatments such as chemical oxidation, chemical reduction, electrochemical and sonochemical methods have failed in this regard. Thus, it is an ongoing challenge to develop a capable treatment technology for in-situ degradation of PFASs and other refractory organic matter.

In view of the foregoing, it would be desirable to identify new processes for treating water that could advantageously reduce the concentration of refractory organic matter.

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

### SUMMARY

The present disclosure is directed to an energy efficient and cost effective water treatment process to degrade and reduce the concentration of refractory organic matter present in water.

In one aspect there is provided a process for treating water contaminated with refractory organic matter comprising the following steps:

(a) acidifying the water containing the refractory organic matter; and

(b) contacting the acidified water with zero valent iron (ZVI) under conditions effective to degrade at least some of the refractory organic matter.

In some embodiments, the process further comprises the step of:

(c) aerating the water comprising degraded refractory organic matter to oxidise iron species formed in step (b) to ferric hydroxide.

Iron removal is an important step in water treatment and is preferably performed in a manner that avoids secondary pollution. As ferric hydroxide is a solid, it may require removal by clarification of water by settling or filtration, as appropriate, prior to discharge or further treatment steps.

In some embodiments, the process further comprises the step of:

(d) clarifying the water.

The process may further comprise a treatment step for degradation and removal of residual contaminants left from partial degradation of organic refractory matter and other organic and inorganic contaminants. The further treatment step may comprise catalytic advanced oxidation, for example as described in the Applicant's Australian Patent Application No. 2016232986, the contents of which are hereby incorporated herein by reference.

Accordingly, in other embodiments, the process further comprises the step of:

(e) subjecting the effluent water from step (b) to catalytic advanced oxidation under conditions effective to, at least partially, remove iron species formed in step (b).

In other embodiments, the effluent from step (e) may be further treated in optional steps (c) and (d).

In some embodiments, step (c) and step (d) may be bypassed and product water from step (b) may be subjected to catalytic advanced oxidation step (e) to remove iron species formed in step (b). Whether this option is desirable, depends on the presence of suspended or colloidal matter and the concentration of released iron species from step (b). Product water from step (b) with low suspended or colloidal matter (about 10 mg/L) and iron species concentration up to about 20 mg/L may be favourably subjected to step (e) after step (b).

In the catalytic advanced oxidation step (e), the water is treated with an inorganic oxidizing salt and sodium hypochlorite.

Typically, catalytic advanced oxidation has a polishing effect in removing remaining contaminants through processes such as precipitating remaining iron, co-precipitation of heavy metals, degradation of dissolved organic material and inactivation and destruction of pathogens such as coliforms. The inorganic oxidising salt advantageously includes manganese or iron. Preferred for its oxidation efficiency, and ability to cost effectively generate manganese hydroxides in situ which act as a coagulant, is a metal permanganate (manganese containing), especially potassium permanganate. Other permanganates may be used including sodium permanganate, barium permanganate, calcium permanganate and aluminium permanganate, but not limited to this group. Barium and calcium permanganates may be favoured if sulphate removal is required. Aluminium permanganate may be favoured for enhanced coagulation and co-precipitation of metals. Generally, the Applicant has found that these permanganates oxidise a broad range of organic substances (for example aldehydes, such as formaldehyde, and compounds containing polycyclic carbon rings) to a non-toxic or less toxic form. Reaction products are at least more susceptible to further oxidation in subsequent oxidation steps where advantageously used.

Concentration of permanganate in water for step (e) may be targeted in range 0.1 to 10 mg/L with less than 5 mg/L being practical and effective for contaminant removal in accordance with the process. There is no requirement to add chelating agents such as amines or phosphates together with the permanganate.

Ferrate (iron containing) may less preferably be used because it is expensive to prepare and subject to unacceptable instability unless generated on site. Ferrate may, however, be suitable for some applications where ferrate generating apparatus is available.

Use of permanganate also tends to favour formation of sufficient manganyl and hydroxyl radicals to achieve co-precipitation of the metals and other contaminant reduction processes which may be sufficient to achieve potable water standards. This result is achieved without recourse to physical oxidation methods such as through use of corona discharge or ultraviolet radiation steps. In addition, the Applicant has not found such radical stability to be an issue in effecting contaminant removal so addition of chelating agents such as polyamines and phosphate salts is not required.

Catalytic oxidation may be conducted in a range of vessels including bed reactors, column reactors or filter beds. Such beds would comprise a granular catalytic material to further catalyse the catalytic oxidation process. Favoured catalytic materials are granules consisting of silica or alumina supported metal oxides or mixtures of metal oxides selected from the group consisting of manganese oxide (green sand and others), manganese dioxide, iron oxides, aluminium oxides, titanium dioxide, perovskite and rare earth oxides. The maximum content of the catalytic component is about 10 wt. % of the total weight of a catalytic granule. Catalytic materials may be arranged in layers in possible combination with other materials which assist filtration of oxidation products from water. Examples of such materials include silica sand and filter coal.

Other catalysts that could be used include zeolites and electrically conductive catalytic materials where granular activated carbon is typically used as a support for a metal. Catalytic elements for such case include noble metals (platinum, gold, silver and nickel) and copper.

Efficient use of permanganate, in terms of cost and contaminant removal, is achievable through the process. This may be demonstrated, for example, by treated water from catalytic oxidation step (e) having no visible colouration due to the presence of residual potassium permanganate even where water prior to catalytic oxidation step (e) has visible colouration due to presence of potassium permanganate. Similar benefit is expected for like permanganates.

In embodiments of the present processes, the refractory organic matter comprises one or more per- and polyfluoroalkyl substances (PFASs), phenols, polycyclic aromatic hydrocarbons, and amines.

In some embodiments, the per- and polyfluoroalkyl substances (PFASs) comprise one or more per- and polyfluorocarboxylic acids or conjugate bases thereof.

In embodiments, the one or more per- and polyfluoroalkyl substances (PFASs) comprise one or more of perfluorooctanoic acid (PFOA), perfluorooctanesulfonate (PFOS), perfluorohexane sulfonic acid (PFHxS) and perfluorohexanoic acid (PFHxA).

In embodiments, in step (a), acidifying the water may be achieved through addition of a suitable acid, a non-limiting example of which is sulphuric acid.

In some embodiments, on acidification, the pH is lowered to less than about 4.

In some embodiments, on acidification, the pH is lowered to between about 2.5 to about 3.5.

The selected pH depends on the optimum process conditions with regard to cost of treatment and, more particularly, the input costs for acid and materials of construction for the hydrolysis. Lower pH intensifies acidification but at the same time increases the requirements for acid-resistant components in the reducing reactor.

Step (a) may be performed at ambient temperatures, for example between about 10° C. and about 30° C., and atmospheric pressure (ca. 100 kPa). The time for step (a) may be between about 1 minute to about 10 minutes.

In embodiments, the catalytic reduction step (b) degrades the refractory organic matter, for example, PFASs

In embodiments, greater than 90% of the refractory organic matter is degraded in step (b) to non-refractory components. In some embodiments, greater than 95%, or greater than 97%, of refractory organic matter is degraded in step (b) to non-refractory components.

In embodiments, greater than 90% of PFASs are degraded in step (b) to non-PFAS components. In some embodiments, greater than 95%, or greater than 97%, of PFASs are degraded in step (b) to non-PFAS components.

In embodiments, greater than 90% of refractory organic matter is degraded in step (b) combined with catalytic advanced oxidation step (e) to non-refractory components. In some embodiments, greater than 95%, or greater than 97%, or greater than 98%, or greater than 99%, of refractory organic matter is degraded in step (b) combined with catalytic advanced oxidation step (e) to non-refractory components.

In embodiments, greater than 90% of PFASs are degraded in step (b) combined with catalytic advanced oxidation step (e) to non-PFAS components. In some embodiments, greater than 95%, or greater than 97%, or greater than 98%, or greater than 99%, of PFASs are degraded in step (b) combined with catalytic advanced oxidation step (e) to non-PFAS components.

In embodiments, step (b) removes more than 90%, or more than 95%, or more than 97% of the refractory organic matter present in the contaminated water.

In embodiments, step (b) removes more than 90%, or more than 95%, or more than 97% of the PFASs present in the contaminated water.

In embodiments, step (b) may comprise catalytic reduction of the refractory organic matter. In the cases of PFASs, the catalytic reduction may comprise at least the steps of decarboxylation and release of fluorine from the PFASs.

In embodiments, the zero-valent iron is converted during the catalytic reduction to a mixture of ferrous hydroxide and ferrous bicarbonate in equilibrium.

Step (b) may be performed at ambient temperatures, for example between about 10° C. and about 30° C., and atmospheric pressure (ca. 100 kPa). The time for step (b) may be between about 5 minutes to about 1 hour.

In embodiments of the process, the zero-valent iron (ZVI) is in the form of granulated or powdered iron.

The particle size of the zero-valent iron may be between about 100 micron and 2000 micron, or between about 175 micron and about 1000 micron, or between about 250 micron and about 400 micron.

The particle size may be determined by common methods known in the art, such as through sieving or using laser diffraction analysis.

In embodiments treatment step (c) comprises one or more of oxygen and air.

In some embodiments, aeration is conducted under alkaline conditions and iron bicarbonate formed in treatment step (b) decomposes into ferrous hydroxide and carbon dioxide.

In some embodiments, the ferrous hydroxide is further oxidised to ferric hydroxide which forms as a precipitate as follows:

Fe(HCO₃)₂→Fe(OH)₂+CO₂

4Fe(OH)₂+O₂+2H₂O→4Fe(OH)₃

In some embodiments, at least some of the carbon dioxide is removed by venting.

Step (c) may be performed at ambient temperatures, for example between about 10° C. and about 30° C., and atmospheric pressure. The time for step (c) may be between about 5 minutes to about 1 hour.

In embodiments, in treatment step (d), the ferric hydroxide precipitate from aeration step (c) is coagulated, for example with calcium hydroxide or magnesium hydroxide.

In treatment step (d), clarification, the ferric hydroxide precipitate from aeration step (c) is coagulated, conveniently with calcium hydroxide or magnesium hydroxide, slightly raising the pH to improve precipitation of iron and remove, in part, fluoride as HF or as calcium or magnesium fluoride precipitates dependent on pH.

In some embodiments separation of settable solids is performed using a settler or clarifier.

Prior to step (a), there may be conducted an optional initial step of clarifying the water to remove suspended and colloidal matter by conventional water treatment processes. Whether this step is required depends on the presence of suspended or colloidal matter. Clarification pre-treatment for removal of suspended and colloidal solids is preferably conducted in a manner in which absorption of PFASs in any sludge produced by clarification is minimal. This is facilitated by the low electric charge of PFASs but strong absorbents like powder activated carbon are preferably avoided unless the intent is to remove PFASs through absorption and separation of the sludge from clarification.

In some embodiments, the water comprises one or more of ground water (e.g. borewater), surface water (e.g. water from lakes, rivers, dams, and ponds), and municipal wastewater such as secondary and tertiary effluents to be treated to required water quality standards for use or safe discharge into the environment. In addition to treatment for degradation and removal of PFASs the herein disclosed process may be used for treatment of water containing other refractory organic matter where biological and other treatment processes may not be efficient or economically suitable.

In another aspect there is provided a system for treating water contaminated with refractory organic matter, comprising at least one vessel configured for (a) acidifying the water containing the refractory organic matter; and (b) contacting the acidified water with zero valent iron (ZVI) under conditions effective to degrade at least some of the refractory organic matter.

In embodiments, the system comprises acidification tank(s) for step (a); and ZVI reactor(s) for step (b).

In embodiments, the system further comprises a ZVI feed system, for example an iron granule or powdered iron feed system.

In some embodiments the ZVI reactor is an upflow reactor. This is preferable because the ZVI granules dissolve and decrease in size until completely dissolved. In a downflow column, the flow may be restricted by small size particles of ZVI forming a compact bed.

The system may further comprise vessels for aerating the water comprising degraded refractory organic matter to oxidise iron species formed in step (b) to ferric hydroxide; and clarifying the water.

A conventional settler or clarifier may be used for clarification, for example a lamella clarifier provided downstream of one or both of a coagulation tank and flocculation tank. For small capacity clarification systems, the coagulation tank and/or flocculation tank are conveniently integrated with the lamella clarifier.

Further features and advantages of the present disclosure will be understood by reference to the following drawings and detailed description.

### BRIEF DESCRIPTION OF THE DRAWINGS

A preferred, non-limiting embodiment of the water treatment process and system for water treatment of the present disclosure is further described with reference to the following figures in which:

FIG. 1 is a schematic flowsheet for a process and system for water treatment according to one embodiment of the present disclosure.

FIG. 2 shows a schematic reaction chain for the degradation of PFOA according to the process and system flowsheet of FIG. 1.

### DETAILED DESCRIPTION OF THE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure.

Although any processes and materials similar or equivalent to those described herein can also be used in the practice or testing of the present disclosure, the preferred processes and materials are now described.

It must also be noted that, as used in the specification and the appended claims, the singular forms ‘a’, ‘an’ and ‘the’ include plural referents unless otherwise specified. Thus, for example, reference to ‘PFAS’ may include more than one PFASs, and the like.

Throughout this specification, use of the terms ‘comprises’ or ‘comprising’ or grammatical variations thereon shall be taken to specify the presence of stated features, integers, steps or components but does not preclude the presence or addition of one or more other features, integers, steps, components or groups thereof not specifically mentioned.

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14th Edition, by R. J. Lewis, John Wiley & Sons, New York, N.Y., 2001.

Unless specifically stated or obvious from context, as used herein, the term “about” is understood as within a range of normal tolerance in the art, for example within two standard deviations of the mean. ‘About’ can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term ‘about’.

Any processes provided herein can be combined with one or more of any of the other processes provided herein.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

As used herein, the term ‘refractory organic matter’ refers to organic compounds possessing a poor biodegradability and/or a low value for the ratio of biological oxygen demand (BOD) to chemical oxygen demand (COD. Exemplary refractory organic matter includes classes of compounds such as PFASs, phenols, polycyclic aromatic hydrocarbons, and amines.

Reference will now be made in detail to exemplary embodiments of the disclosure. While the disclosure will be described in conjunction with the exemplary embodiments, it will be understood that it is not intended to limit the disclosure to those embodiments. To the contrary, it is intended to cover alternatives, modifications, and equivalents as may be included within the spirit and scope of the disclosure as defined by the appended claims.

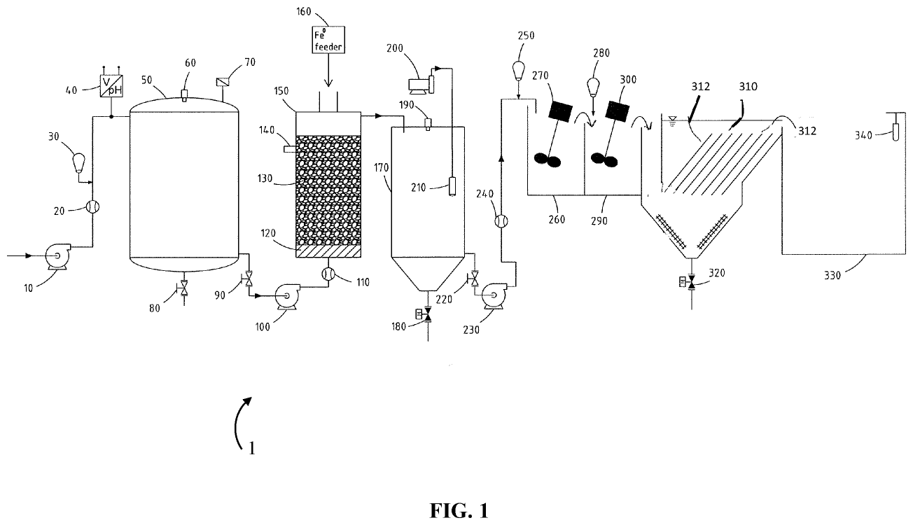

Referring first to FIG. 1: initially clarified water sourced, in this example, from a groundwater source contaminated with PFASs (including PFOA and PFOS) is pumped from water storage by pump 10, into acidification tank 50 of water treatment system 1. Flow of pump 10 is controlled through monitoring flow meter 20 and a variable frequency drive. During water transfer to the acidification tank 50, water is dosed with acid, preferably sulphuric acid, to adjust the pH to desired level, lower than 4. Recommended range for pH is 2.5 to 3.5. The pH is monitored by the pH transmitter 40 and the dosage of acid is adjusted to the target value. Level in tank 50 is monitored by the ultrasonic level transmitter 60. The pump 10 is stopped when the acidification tank 50 is full and pump 100 is stopped when that tank 50 level is at empty point to prevent the pump 100 from running dry. Recommended hydraulic retention time depends on concentration and the nature of the PFASs, including PFOA or PFOS, and other dissolved organics and is typically a minimum 10 minutes to one hour. The acidification tank 50 is provided with air breather filter 70 and discharge valve 80. The valve 80 is used to drain the tank during cleaning and discharge accumulated sediment from time to time.

The acidic water from acidification tank 50 is pumped through the ZVI reactor 150—which is used for catalytically reducing PFASs by zero valent iron (ZVI) catalyst by general principles as illustratively described below—by pump 100. Valve 90 is used for hydraulically isolating the pump. Flow transmitter 110 monitors the flow and the flow of the pump 100 is adjusted to target flow through variable frequency drive.

The housing of the ZVI reactor 150 is made of material(s) resistant to degradation. One suitable material is borosilicate glass with the reactor inner diameter maximum size limit to 450 mm according to current glass manufacturing capability. Above this inner diameter, other corrosion resistant materials could be used such as high corrosion resistant stainless steel alloys. The lower part 120 of the ZVI reactor 150 contains beads of glass (or other inert material) of size 1 to 2 mm forming a fixed bed 120 needed for uniform distribution of water flow in the cross section of the ZVI reactor 150. Those skilled in the art will appreciate that other modes of water flow distribution could be used.

The material above the inert fixed bed 120 is granular ZVI bed 130 to which granulated iron)(Fe⁰) is fed by feeder 160. Size of the iron granules are preferably no larger than 2 mm to optimise dissolution behaviour. Water flows upwards through the ZVI bed 130 to avoid blockage of the ZVI bed 130. As the iron contacts with water it dissolves, driving reduction of PFASs through steps including decarboxylation and release of fluorine as described below.

As iron dissolves, more iron is added using feeder 160. An acceptable level of iron in the ZVI bed 130 is detected by proximity switch 140 and, when the level is lower than position of proximity switch 140, a new batch of iron is added to increase level above the proximity switch 140. Water exiting from the ZVI bed 130 has pH slightly alkaline, just above 7, as a consequence of the reduction process. Contact time of the water with the ZVI in the bed 130 of reactor 150 is around 30 minutes. The opening at the top of the ZVI reactor 150 is needed to allow venting of gasses as well as ZVI feeding, and should not be very large so that contact with atmosphere and undesirable oxygen intrusion is limited. The positive pressure in ZVI reactor 150 (e.g., 100 kPa) due to evolving gases, such as CO₂, assists in excluding oxygen which could oxidise and precipitate ferric hydroxide too soon which could cause problems with water transfer to the aeration tank 170.

Water overflows from ZVI reactor 150 through a pipe connected to the upper side of the ZVI reactor 150, into the aeration tank 170. Air blower 200 pumps air through the fine bubble diffuser 210 for oxidation of ferrous hydroxide to ferric hydroxide which precipitates under the alkaline conditions. The aeration tank 170 is open to atmosphere. Ultrasonic level transmitter 190 monitors the level in the aeration tank 170 to prevent overflow by stopping pump 100, and to prevent pump 230 from running dry, stopping the pump 230 at tank empty level.

Some precipitated ferric hydroxide falls to the bottom of the aeration tank 170 and compacts in time. Electrically operated valve 180 at the bottom of the aeration tank 170 opens intermittently to discharge accumulated ferric hydroxide from the bottom of the aeration tank 170.

Pump 230 is connected to the aeration tank 170 through manually operated valve 220. The function of valve 220 is to hydraulically isolate the pump from the aeration tank 170 for maintenance and service. The flow rate of pump 230 is monitored by flowmeter 240 and the rotational speed of the pump 230 is adjusted through variable frequency drive to the target set flow rate. The target flow rate is set so that aeration tank 170 is maintained close to full level.

During transfer of water from the aeration tank 170 to the coagulation tank 260, the water is dosed with hydrated lime or magnesium hydroxide for pH adjustment and coagulation, preferred pH range being 8 to 9. The dosing unit 250 for the dosing of hydrated lime or magnesium hydroxide may be placed in-line or the coagulant may be dosed directly at the inlet of the coagulation tank. The coagulation tank 260 and flocculation tank 290, for small capacity clarification systems, are conveniently integrated with the lamella clarifier 310 assembly. Coagulation tank 260 is provided with agitator 270. A suitable reaction and coagulation time where using hydrated lime is 20 minutes. Water with coagulated suspended solids flows into flocculation tank 290. At the inlet of the flocculation tank 290, flocculant—e.g. an acrylamide-acrylic acid based polymer—is dosed into the water with dosing unit 280.

Mixing for flocculation is performed using agitator 300. Time for flocculation may be 10 minutes or longer but should typically occur in no more than 20 minutes. Conduct of routine flocculation tests would enable required flocculation time for a particular water matrix to be assessed. Water from the flocculation tank 290 flows into the lamella clarifier 310 where it is distributed over a series of inclined plates. The lamella clarifier 310 settles flocculated suspended solids onto the series of inclined plates 312, then the settled matter slides down to the bottom of the clarifier. Sludge accumulated at the bottom of the clarifier 310 is discharged intermittently through the electrically operated valve 320. By the time water reaches lamella clarifier 310, fluoride is in mineral form. Organic matter is already mineralized. NaF is highly soluble while other forms are not completely soluble (example, CaF₂). The mineral forms of fluoride are not toxic unless present in very high concentration. Ferric hydroxide is removed by settling.

Clarified water flows into treated water storage tank 330. Cable float switch 340 prevents overflow by confirming when the tank is full to the control system. Water from tank 330 could undergo further treatment or could be discharged or reused.

Sludge from all parts of the water treatment system 1 could be accumulated into a common sludge pit. The sludge will contain a small amount of PFASs. Sludge could be further treated for safe disposal if required, though it is predicted to pass the LCTP test.

The process is preferably carried out at ambient pressure and temperature. The water treatment system 1 does not show an initial typical and conventional clarification step for removal of suspended and colloidal solids as this could be carried out in many process variants and is well understood in the water treatment practice.

In a further embodiment (not shown) product waters from the ZVI reactor 150 which have low suspended solids and low iron species concentrations are subjected to catalytic advanced oxidation to remove iron species formed in step. The resulting water, may or may not, be further subjected to further aeration and clarifications steps as described herein.

Through the catalytic advanced oxidation process, the water is initially dosed with an oxidant (such as potassium permanganate and sodium hypochlorite (common chemicals applied by water treatment utilities for the production of drinking water)) to (a) support the advanced oxidation reactions in catalytic filter reactors to maximise the production of oxidative species and (b) prevent growth of bacteria and mould. Then, the conditioned water is pumped into the catalytic filter reactors where highly reactive species are produced in-situ via a catalytic process to oxidise compounds present in the water matrix. Within the catalytic filter reactors, pathogens are destroyed, residual organic matter are degraded, and metals present are precipitated.

Referring once again to ZVI reactor 150, and in particular to processes occurring in that reactor, it will be understood that—due to the large number of organic species and intermediates from reactions—the processes taking place in ZVI reactor 150 are very complex. However, and without wishing to be bound by theory, the processes thought to take place involve use of ZVI as an electron donor (reductant). Reduction through electron transfer is a more powerful degradation process than advanced oxidation process based on hydroxyl radicals which is not able to degrade PFASs.

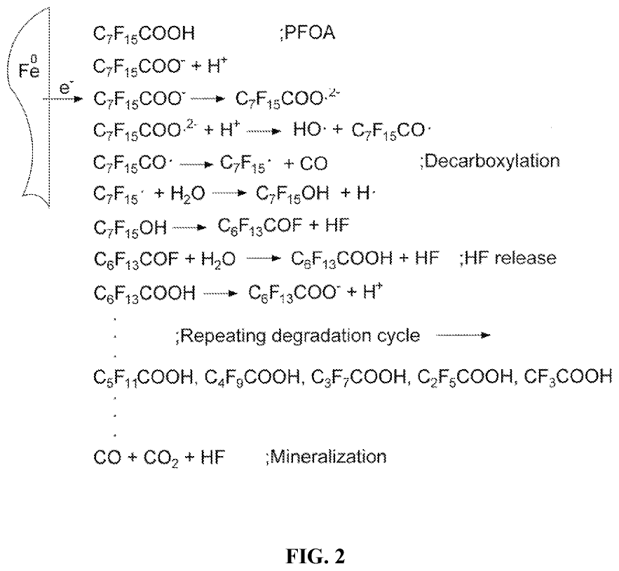

FIG. 2 illustrates a solely schematic reaction chain for the degradation of refractory PFOA by means of the herein described process and system. Under acidic conditions, PFOA is ionized by the following reaction:

C₇F₁₅COOH [symbol] C₇F₁₅COO⁻+H⁺ (I)

Subsequently, the ionized PFOA comes in contact with a surface of a ZVI granule and receives one electron:

C₇F₁₅COO⁻+e→C₇F₁₅COO.²⁻ (II)

Decarboxylation follows:

C₇F₁₅COO.²⁻+H⁺→HO.+C₇F₁₅CO. (IIIa)

C₇F₁₅CO.→C₇F₁₅.+CO (IIIb)

Release of fluorine follows:

C₇F₁₅.+H₂O→C₇F₁₅OH+H. (IVa)

C₇F₁₅OH→C₆F₁₃COF+HF (IVb)

C₆F₁₃COF+H₂O→C₆F₁₃COOH+HF (IVc)

C₆F₁₃COOH [symbol] C₆F₁₃COO—+H⁺ (IVb)

Acidification and a new cycle of degradation follows in which the degradation step repeats as above from the point of electron transfer producing intermediate products:

C₅F₁₁COOH,C₄F₉COOH,C₃F₇COOH,C₂F₅COOH,CF₃COOH (V)

At the end of the degradation process, the PFOA is mineralized to:

CO+CO₂+HF (VI)

The carbon oxide species will form bicarbonate, dissolving oxidised iron from the ZVI granule surface and producing iron bicarbonate:

CO₂+H₂O→HCO₃⁻+H⁺ (VIIa)

Fe²⁺+2HCO₃⁻→Fe(HCO₃)₂ (VIIb)

ZVI is unstable in water under acidic pH and will be corroded to Fe²⁺:

2Fe⁰+H₂O→2Fe²⁺+2OH⁻+H₂ (VIII)

Dissolved oxygen also contributes to corrosion of ZVI and consumption of acidity:

2Fe⁰+O₂+4H⁺→2Fe²⁺+2H₂O (IX)

The ferrous iron can be precipitated to ferric iron in aeration step (c) and the process continues as described above.

### Example 1: PFASs Treatment

Tap water was spiked with PFASs and the resulting water subjected to the herein disclosed process, including steps (a), (b), and, optionally, step (e).

PFASs were analysed by liquid chromatography-mass spectrometry (LC-MS) with a Limit of Report (LOR) of 0.01-0.1 μg/L. The results are collected in Table 1.

TABLE 1

| | | Treated water | Treated water |
|---|---|---|---|
| Compound | Tap Water | without step (e) | with step (e) |
| PFOA (μg/L) | 63.70 | 2.54 | 0.56 |
| Sum of PFOS and | 81.20 | 0.39 | 0.03 |
| PFHxS (μg/L) | | | |
| Sum of PFASs (μg/L) | 146.00 | 3.12 | 0.72 |

It is evident that the presently disclosed processes are highly effective in reducing the concentration of PFASs in water. Utilising acidification followed by zero-valent iron treatment (steps (a) and (b)) resulted in removing greater than 97% of the PFASs from the tap water. Further subjecting the thus treated water to catalytic advanced oxidation (step (e)) resulted in removal of greater than 99% of the PFASs.

### Example 2: Piperazine Degradation

An industrial wastewater sample contaminated with piperazine was subjected to the herein disclosed process including step (a), (b), and (e).

Piperazine was analysed by liquid chromatography-mass spectrometry (LC-MS) with a Limit of Report (LOR) of 1 μg/L. The results are collected in Table 2.

TABLE 2

| | | Treated |
|---|---|---|
| Compound | Raw Water | water |
| Piperazine (μg/L) | 23,000 | 290 |

It is evident that the herein disclosed process effectively reduced piperazine concentration in water, removing greater than 98% of the pollutant.

### Example 3: Industrial Wastewater with High Organic Content

An industrial wastewater sample with high organic content was subjected to the herein disclosed process including step (a), (b), and (e). Chemical oxygen demand (COD) of the water was determined by oxidation with potassium dichromate in a 50% sulfuric acid solution. Biological oxygen demand (BOD) was determined by monitoring dissolved oxygen of a sample placed in a dark incubator at 20° C. for five days. The change in dissolved oxygen over 5 days was used to calculate BOD.

The results are collected in Table 3.

TABLE 3

| | | Treated |
|---|---|---|
| Compound | Raw Water | water |
| COD (mg/L) | 2120 | 620 |
| BOD (mg/L) | 6 | 244 |

The significant decrease in (COD) (>70%) and the simultaneous increase in biological oxygen demand (BOD) (>40 times) highlight the potential of the disclosed processes to degrade refractory organic matter to biodegradable organic matter.

The contents of all references and published patents and patent applications cited throughout the application are hereby incorporated by reference. Those skilled in the art will recognize that the disclosure may be practiced with variations on the disclosed materials, compositions and processes, and such variations are regarded as within the ambit of the disclosure.

It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A process for treating water contaminated with refractory organic matter, the process comprising the following steps:
(a) acidifying the water containing the refractory organic matter; and
(b) contacting the acidified water with zero valent iron (ZVI) under conditions effective to degrade at least some of the refractory organic matter.

2. A process according to claim 1, further comprising the step of:
(c) aerating the water comprising degraded refractory organic matter to oxidise iron species formed in step (b) to ferric hydroxide.

3. A process according to claim 2, further comprising the step of:
(d) clarifying the water.

4. A process according to claim 1, further comprising the step of:
(e) subjecting water effluent from step (b) to catalytic advanced oxidation under conditions effective to, at least partially, remove iron species formed in step (b).

5. A process according to claim 1, wherein the refractory organic matter comprises one or more per- and polyfluoroalkyl substances (PFASs), polycyclic aromatic compounds, phenols and amines.

6. A process according to claim 5, wherein the per- and polyfluoroalkyl substances (PFASs) comprise one or more per- and polyfluorocarboxylic acids or conjugate bases thereof.

7. A process according to claim 1, wherein the water is acidified through addition of a suitable acid, preferably sulphuric acid.

8. A process according to claim 1, wherein the zero-valent iron (ZVI) is in the form of granulated or powdered iron.

9. A process according to claim 8, wherein the particle size of the zero-valent iron is between about 100 micron and 2000 micron, or between about 175 micron and about 1000 micron, or between about 250 micron and about 400 micron.

10. A process according to claim 1, wherein step (b) is performed in an upflow reactor.

11. A process according to claim 1, wherein zero-valent iron is converted during step (b) to ferrous hydroxide and ferrous bicarbonate in equilibrium.

12. A process according to claim 11, wherein aeration is conducted under alkaline conditions and iron bicarbonate formed in treatment step (b) decomposes into ferrous hydroxide and carbon dioxide.

13. A process according to claim 11, wherein the ferrous hydroxide is further oxidised to ferric hydroxide as a precipitate.

14. A process according to claim 13, wherein in treatment step (d), the ferric hydroxide precipitate from aeration step (c) is coagulated, for example with calcium hydroxide or magnesium hydroxide.

15. A process according to claim 4, wherein step (e) comprises treatment with one or more metal permanganates.

16. A process according to claim 1, wherein prior to step (a), the water is clarified to remove suspended and colloidal matter.

17. A process according to claim 1, wherein the water comprises one or more of ground water (e.g. borewater), surface water (e.g. water from lakes, rivers, dams, and ponds), and municipal wastewater, such as secondary and tertiary effluents to be treated to required water quality standards for use or safe discharge into the environment.

18. A system for treating water contaminated with refractory organic matter, the system comprising at least one vessel configured for:
(a) acidifying the water containing the refractory organic matter; and
(b) contacting the acidified water with zero valent iron (ZVI) under conditions effective to degrade at least some of the refractory organic matter.

19. A system according to claim 18, wherein the system comprises acidification tank(s) for step (a) and ZVI reactor(s) for step (b).

20. A system according to claim 19, further comprising a ZVI feed system, for example an iron granule or powdered iron, feed system.
